(19) United States
(12) Patent Application Publication
(10) Pub. No.: US 2017/0297031 A1
(43) Pub. Date: Oct. 19, 2017

(54) DISC PULVERIZING MILL

(71) Applicant: James Hummel, Phoenix, AZ (US)

(72) Inventor: James Hummel, Phoenix, AZ (US)

(21) Appl. No.: 15/130,834

(22) Filed: Apr. 15, 2016

(51) Int. Cl. B02C 7/17; B02C 7/08; B02C 7/14; B02C 25/00

(52) U.S. Cl. CPC B02C 7/17; B02C 25/00; B02C 7/08; B02C 7/14

(57) ABSTRACT

A method and system for of cooling a disc mill having a rotating disc blade is disclosed. A disc mill may have a first and second material outlet positioned generally along tangents to the rotating disc blade. Air may be drawn through the first and second material outlets. A disc mill may include first and second air inlets positioned generally along tangents to the rotating disc blade. The first and second inlets may direct air streams to cool a first and second portion of the rotating disc blade and pulverized material.

### BACKGROUND

### 1. Technical Field

This disclosure relates to machines for solid material comminution or disintegration with a rotary cooperating service, and specifically relates to disc pulverizing mills with opposed flat coaxial surfaces.

### 2. Background Art

Disc mills are used to pulverize raw material, such as plastics in pellet form, into a powder form to be used in a manufacturing process. One of the challenges in pulverizing materials is the production of heat as material is broken from larger particles into smaller particles. Each raw material will have a melting temperature. If the pulverized material are allowed to get near or reach the melting temperature particles can agglomerate and form into a mass and damage the mill and prevent the mill from operating properly.

When the temperature in a disc mill approaches a melting point of the material, the temperature may be maintained or reduced by slowing the speed of material introduced into the mill. The result is a reduction in the output of the mill. If the mill is supplying material for ongoing manufacturing, then the speed of the entire manufacturing process might need to be reduced because of the limitation of the disc mill to supply the needed pulverized material.

There is a need to provide a disc mill with increased ability to supply an output volume of pulverized material while maintaining an acceptable operating temperature.

### BRIEF SUMMARY

A method of cooling a disc mill having a rotating disc blade, may include drawing air through a first material outlet. The first material outlet may be positioned generally along a first line forming a first tangent to an outer circumference of the rotating disc blade. The method may include drawing air through a second material outlet. The second material outlet may be positioned generally along a second line forming a second tangent to the outer circumference of the rotating disc blade. The method may include directing a first air stream from a first air inlet along a first portion of the rotating disc blade to cool the rotating disc blade and pulverized material, and directing a second air stream from a second air inlet across a second portion of the rotating disc blade to cool the rotating disc blade and pulverized material.

The step of directing the first air stream may include directing the first air stream generally along a third line that forms a third tangent to the outer circumference of the rotating disc blade. The first air stream may be directed generally along the third line at an angle relative to the first line between zero degrees and seventy degrees in some embodiments. In other embodiments the third line may be at an angle relative to the first line between five degrees and thirty-five degrees. In other embodiments the first air stream may be generally directed along the third line at an angle of approximately ten degrees relative to the first line.

The step of directing the second air stream may include directing the second air stream generally along a fourth line that forms a fourth tangent to the outer circumference of the rotating disc blade. The step of directing the second air stream may include directing the second air stream generally along the fourth line at an angle relative to the first line between zero degrees and Seventy degrees, or between.

The step of directing the second air stream may include directing the second air stream generally along a fourth line that forms a fourth tangent to the outer circumference of the rotating disc blade, wherein the fourth line and the third line are generally along opposite tangents to the rotating disc blade.

The step of drawing air through the second material outlet may include drawing air along the second line. The first line and the second line may be generally along opposite tangents to the rotating disc blade.

The method may include measuring a first temperature inside the disc mill at the first material outlet with a first thermocouple and measuring a second temperature inside the disc mill at the second material outlet with a second thermocouple. The method may include measuring power to a motor that rotates the rotating disc blade, and regulating a volume of material introduced into the disc mill based on the power to the motor, the first temperature and the second temperature.

A disc mill housing for a rotating disc blade may include multiple material outlets in the disc mill housing including a first material outlet positioned generally along a first line forming a first tangent to an outer circumference of the rotating disc blade, and a second material outlet positioned generally along a second line forming a second tangent to the outer circumference of the rotating disc blade. The disc mill housing may include multiple air inlets in the disc mill housing including a first air inlet generally along a third line that forms a third tangent to the outer circumference of the rotating disc blade, and a second air inlet generally along a fourth line that forms a fourth tangent to the outer circumference of the rotating disc blade.

The multiple material outlets may be generally spaced evenly around the rotating disc blade, and The multiple air inlets may be generally spaced evenly around the rotating disc blade. The first line and the second line may be generally along opposite tangents to the rotating disc blade, and the third line and the fourth line may be generally along opposite tangents to the rotating disc blade.

The multiple material outlets may each have an outlet cross section with an outlet area. The outlet area may be substantially equal for each of the multiple material outlets. The multiple air inlets may each have an inlet cross section with an inlet area and the inlet area may be substantially equal for each of the multiple air inlets. The inlet area may be smaller than the outlet area.

A mill assembly may include a disc mill housing with a first material outlet, a second material outlet located about one-hundred-eighty degrees from the first material outlet, a first air inlet, and a second air inlet located about one-hundred-eighty degrees from the first air inlet. The mill assembly may include a mill door with a hinge connected to the disc mill housing and fasteners to securely position the mill door relative to the disc mill housing.

The mill assembly may include a stationary blade assembly with a water jacket support that may be connected to the mill door, a stationary disc blade that may be attached to the water jacket support. The stationary disc blade may be attached to the water jacket support with multiple inner clamp segments and multiple outer clamp segments.
The mill assembly may include a rotating blade assembly with a flywheel, and a rotating disc blade attached to the flywheel. The rotating disc blade may be attached to the flywheel with multiple outer clamp segments. The rotating disc blade may be positioned facing the stationary disc blade, with a gap between the rotating disc blade and the stationary disc blade.
The mill assembly may include a motor mechanically linked to the flywheel and configured to rotate the flywheel with the rotating disc blade relative to the stationary disc blade. A blade adjuster may change the gap between the rotating disc blade and the stationary disc blade.

### BRIEF DESCRIPTION OF THE DRAWINGS

FIG. 1 is a perspective view of an embodiment of a disc mill with a direct drive motor;

FIG. 2 is a perspective view of an embodiment of a disc mill housing.

FIG. 3 is front view of mill system according to some embodiments.

FIG. 4 is a top cut-away view of a disc mill housing shown in FIG. 1 along the line B-B.

FIG. 5 is a side cut away view of the embodiment shown in FIG. 1 along the line A-A.

FIG. 6 is a portion of the side cut away view of the embodiment shown in FIG. 5.

FIG. 7 is a side cut away view of a blade adjuster according to some embodiments.

### DETAILED DESCRIPTION

In some embodiments a motor may be configured to rotate at a fixed operating speed. The introduction of material into the mill will cause resistance, which will increase the power or amps required to maintain the fixed speed of the motor. Disc mill systems often get too hot before the motor is at full power. This means that the motor is not working to full capacity most of the time. This also means that the throughput, or output of the mill over a time period is reduced based on the temperature limitations of the mill. Mills have areas in them that are hotter than other areas. When the temperature in a mill gets too high material may stick together or agglomerate. This is contrary to the purpose of the mill, as the purpose of the mill is to reduce the particle size of the material. If the hot material that has agglomerated exits out of the mill housing and cools without sticking to anything, it can be recycled back into the mill as a larger particle as described below. If the melted material sticks to other material inside the mill housing, the material can gather and create a large amount of material . In some cases agglomerated material can gather together at deadspots until it builds up and contacts the rotating mill. If agglomerated material contacts moving parts friction may cause the material to melt and then cooling will cause the material to form into a solid mass. The friction with the moving parts of the mill may cause rapid wear or damage to the mill.

Disc mills may have deadspots where airflow or cooling power is lower than at other areas. In some cases these deadspots become the limiting factor for temperature. If the temperature at a deadspot gets near to or higher than the melting point of the material, then the material may stick together or agglomerate and stay in the deadspot. When material sticks together at the deadspot this may damage the system. The limiting factor in many mill systems is the temperature, and in some systems a limiting area of the mill for temperature is a deadspot, therefore there is a need to reduce the temperature in deadspots or eliminate deadspots in disc mills.

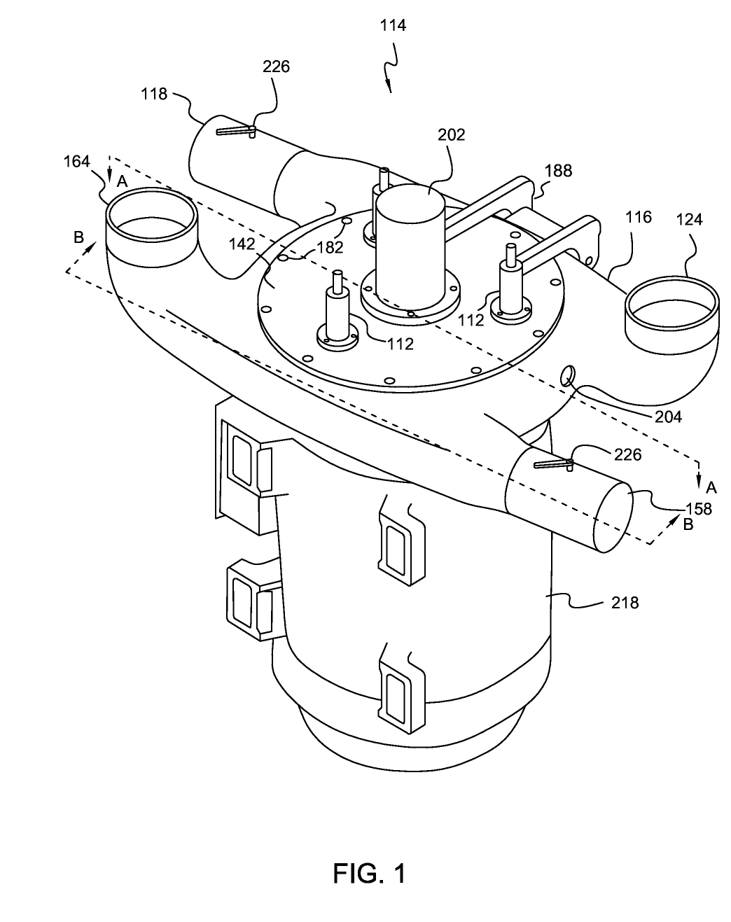

A disc mill 114 according to some embodiments is shown in FIG. 1. The example disc mill 114 may include a first air inlet 118, a second air inlet 158, a first material outlet 124 and a second material outlet 164. The disc mill 114 may include a motor 218, for example a direct drive motor. The disc mill 114 may have a mill housing 116 connected to a hinge 188. The hinge 188 may be connected to a mill door 142 that is secured to the mill housing 116 with fasteners 182 while the mill is in operation. The hinge 188 may allow the mill door 142 to be opened for maintenance of the disc mill 114.

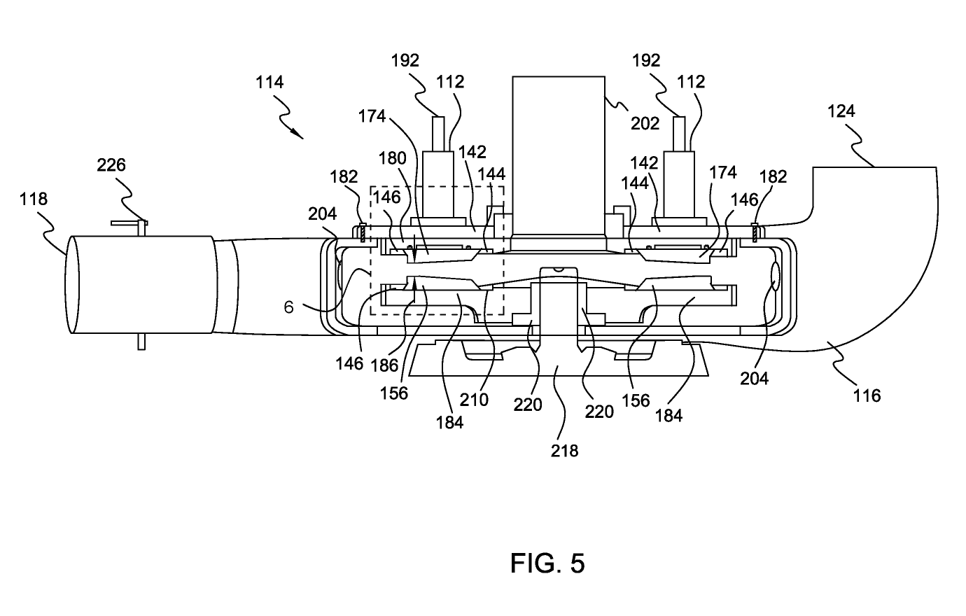

In some embodiments a disc mill 114 may include blade adjusters 112 that are connected to the mill door 142, and which may allow an adjustment of a stationary disc blade 174 (shown in FIG. 5). The blade adjusters 112 may allow the stationary disc blade 174 to be moved without opening the mill door 142. In some embodiments gap gage access holes 204 may be included in the sides of the housing to allow a gage to measure the gap 186 between the stationary disc blade 174 and the rotating disc blade 156 (see FIG. 5). The gap gage access holes 204 may be plugged when the mill is in operation, and the plug may be removed to measure and adjust the gap 186 between the blades. The mill housing 116 may have a gap gage access hole 204 that corresponds with each of the blade adjusters 112. The gap 186 can be different in different locations if the blade adjusters 112 are not adjusted evenly. In some embodiments the goal is to adjust the gap 186 to be substantially the same as measured in multiple locations. In some embodiments a disc mill 114 may have three blade adjusters 112 to adjust the gap 186 in three locations, and three corresponding gap gage access holes 204 to measure the gap 186 in three locations corresponding to the three blade adjusters 112.

The mill door 142 may include a material inlet 202, where material to be pulverized may be introduced into the disc mill 114. The first air inlet 118 and the second air inlet 158 may include an inlet baffle 226 that may be used to limit the amount of air flow into the disc mill 114.

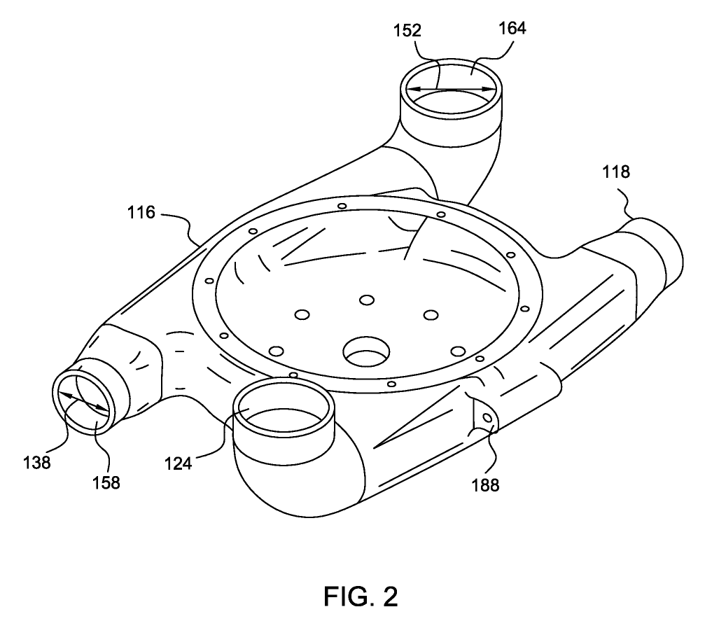

A mill housing 116 according to some embodiments is shown in FIG. 2. In some embodiments air inlets 118, 158 may have a smaller cross section area than the cross section area of the material outlets 124, 164. The air inlets 118, 158 may have an inlet diameter 138 that defines the cross section area of the air inlet 118, 158. The material outlets 124, 164 may have an outlet diameter 152 that defines the cross section area of the material outlet 124, 164. In some embodiments the cross section area of the air inlets is the most limiting area of the air inlets 118, 158 and may have the smallest cross section area of the air inlets 118, 158. In some embodiments the cross section area of the material outlets is the most limiting area of the material outlets 124, 164 and may have the smallest cross section area of the material outlets 124, 164. In some embodiments the total cross section area of the material outlets 124, 164 is greater than the cross section of the air inlets 118, 158. An example mill housing may have two air inlets 118, 158 of equal size and two material outlets 124, 164 of equal size. Having a smaller input area on the air inlets may increase the velocity of the air at the air inlets, and may allow for greater cooling, as well as more direction of the material away from the air inlet and generally towards the material outlet. An increased velocity of air at the air inlet may draw air from areas that may be potential deadspots or hot spots in the housing. Material generally may be the highest temperature as it exits the space between the disc blades, as the process of breaking the material into smaller pieces generates friction and heat. Providing multiple air inlets and multiple material outlets may provide for greater cooling effect in critical areas, and therefore allow a higher throughput or output of a mill thereby lowering the costs.

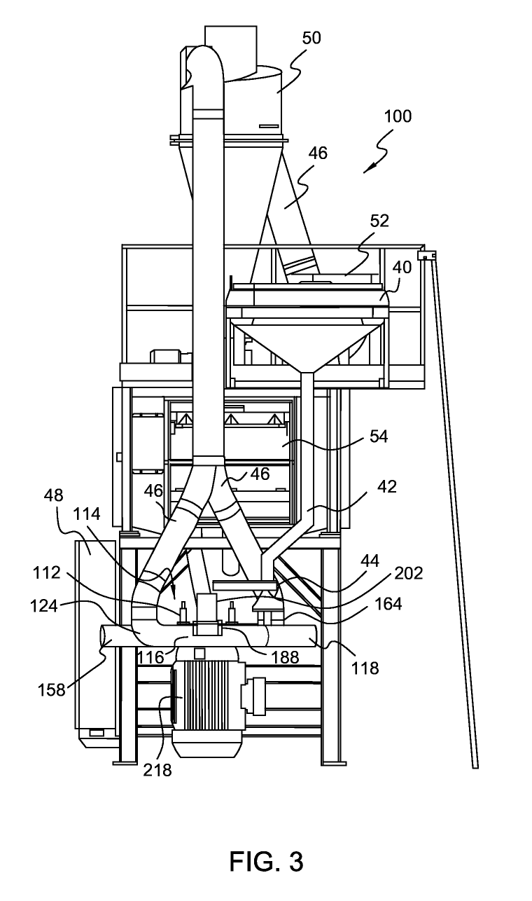

FIG. 3 shows a front view of a mill system 100 according to some embodiments. The mill system 100 may operate with raw material starting in a raw material bin 40. A material tube 42 may connect to the raw material bin 40 and deliver raw material to a material feeder 44. The material feeder 44 may control the flow of material into the material inlet 202. A motor 218 may drive a rotating disc mill to pulverize the raw material. The mill system 100 may include a vacuum blower 52 to create a flow of air in vacuum tubes 46. The vacuum blower 52 may be connected to a cyclone 50 with a vacuum tube 46, and may draw air out of the cyclone 50. The cyclone 50 may draw air from vacuum tubes 46 that are connected to the material outlets 124, 164. The material outlets 124, 164 may draw air from the mill housing 116. The mill housing 116 may draw air in through air inlets 118, 158.

The cyclone 50 may separate the pulverized material from the air stream. The cyclone 50 may be connected to a sifter 54 and may allow the pulverized material to fall into the sifter 54. The sifter 54 may separate larger material particles from small material particles. The small material particles that are the appropriate size may be passed out of the sifter through one exit, and larger sized material particles may be reintroduced into the material inlet 202 of the disc mill 114.

A controller 48 may include controls that are connected to the motor 218, the material feeder 44, the vacuum blower 52 and sensors. The controller 48 may regulate the material feeder 44 based on motor power and measured temperature and conditions measured by the sensors.

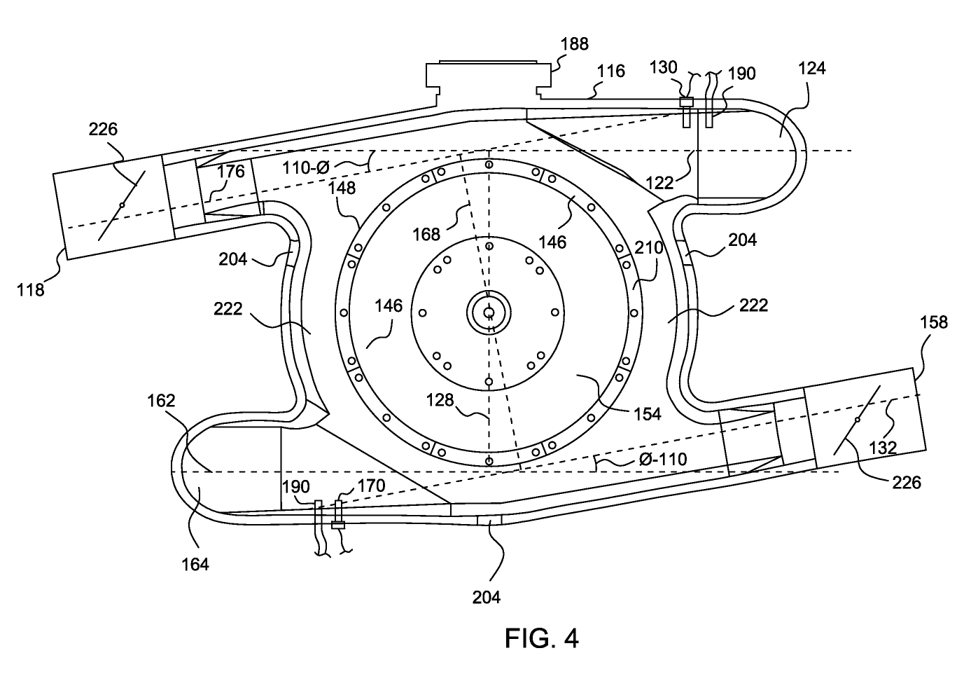

FIG. 4 shows a top view of a mill housing 116 that is cut away along the line B-B of FIG. 1. The rotating blade assembly 154 can be seen in the mill housing 116. In some embodiments the placement and angle of the air inlet relative to the material outlet may be useful to reduce or eliminate deadspots or hotspots in a mill housing. The material outlets 124, 164 may be connected to a vacuum that draws air and pulverized material out of the mill housing 116. As the goal is to have pulverized material exit the housing, the air inlet may be separated from the material outlet to prevent or reduce the amount of material that is drawn around towards the air inlets 118, 158 rather than exiting through the material outlets 124, 164. At the same time if there is insufficient air flow between an air inlet and a material outlet, a deadspot may develop that may become a heat problem and limiting factor in the throughput of the system.

In some embodiments multiple material outlets 124, 164 may be positioned generally along tangents to the outer circumference 148 of the rotating blade assembly 154. The multiple material outlets 124, 164 may be positioned in the mill housing 116 approximately at equal intervals around the rotating disc blade assembly 154. The multiple material outlets 124, 164 may encourage multiple air streams along multiple tangents to the outer circumference 148 of the rotating blade assembly 154. In some embodiments the shape, position and angles of the mill housing 116 will determine the direction of the air streams inside the mill housing 116.

In some embodiments the mill housing 116 may have two material outlets 124, 164 that are generally along opposite tangents to the rotating disc blade. A first line 122 may be a tangent to the rotating blade assembly 154, and the first material outlet 124 may be generally along the first line 122. A second line 162 may be a tangent to the rotating blade assembly 154, and the second material outlet 164. The first line 122 and the second line 162 may be at approximately one-hundred-eighty degrees from each other. The first line 122 and the second line 162 may be approximately on opposite sides of the housing and may generally be along air streams along opposite tangents of the rotating blade assembly 154 inside the mill housing 116. A first diameter line 128 is drawn perpendicular to the first line 122 and the second line 162 for illustration in an example embodiment to show the first line 122 and second line 162 as parallel lines and opposite tangents.

The mill housing 116 may have two air inlets 118, 158. The first air inlet 118 may direct the air along a third line that is a tangent to the rotating blade assembly 154, and the second air inlet 158 may direct the air along a fourth line 132 that is a tangent to the rotating blade assembly 154, with each of the air inlets 118, 158 generally directing an air stream towards the two material outlets 124, 164. The two air inlets 118, 158 may direct air streams generally along opposite tangents to the rotating blade assembly. A second diameter line 168 is drawn perpendicular to the third line 176 and the fourth line 132 for illustration in an example embodiment to show the third line 176 and fourth line 132 as parallel lines and opposite tangents.

In some embodiments there may be an inlet-outlet angle 110 between the tangent of the air stream from the air inlet and the angle of the air stream from the material outlet, which may be between generally zero degrees and seventy degrees. The inlet-outlet angle 110 may be generally between five degrees and thirty-five degrees. In some embodiments the inlet-outlet angle 110 may be generally about ten degrees.

When multiple air inlets 118, 158 are generally equally spaced around the rotating blade assembly 154, and multiple material outlets 124, 164 are also spaced around the rotating blade assembly 154, there will be a turning section 222 of the housing between each material outlet and each air intake. When the inlet-outlet angle 110 is increased the distance of the turning sections 222 will be decreased. Turning sections 222 may be areas that are more likely to have hotspots or deadspots with lower air flow. Deadspots, or temperature problems in the turning section 222 may be decreased by making the inlet-outlet angle 110 an angle greater than zero degrees.

In some embodiments the housing has three material outlets that are generally along three tangents to the rotating disc blade, and the three tangents are approximately one-hundred-twenty degrees from each other. Air inlets may be placed along three tangents to the rotating disc blade that are approximately one-hundred-twenty degrees from each other. With three inlets and three outlets, the turning sections 222 may be reduced, even without increasing the inlet-outlet angle 110 above zero, thereby reducing temperature problems in deadspots.

In some embodiments multiple sensors may be used to measure temperature and conditions inside the mill housing 116. A first thermocouple 130 may measure the temperature inside the housing near or at the first material outlet 124. A second thermocouple 170 may measure temperature inside the mill housing 116 at or near the second material outlet 164. In some embodiments heat from the pulverized material is released into the air, heating the air, and as the air stream comes from outside the mill housing 116 through the air inlets 118, 158 towards the material outlets 124, 164, the air is heated and becomes hotter as more material enters the air stream and heats the air stream. In some embodiments the air is hottest at or near the material outlet. Meltdown sensors 190 may be placed at multiple locations near or at the material outlets 124, 164. A meltdown sensor 190 may have a small opening with a vacuum drawn through the opening. A sensor may measure the vacuum drawn through the small opening. When material begins to melt, the melted material may clog the small opening and change the vacuum measured, thereby giving an early indication that material has begun to melt.

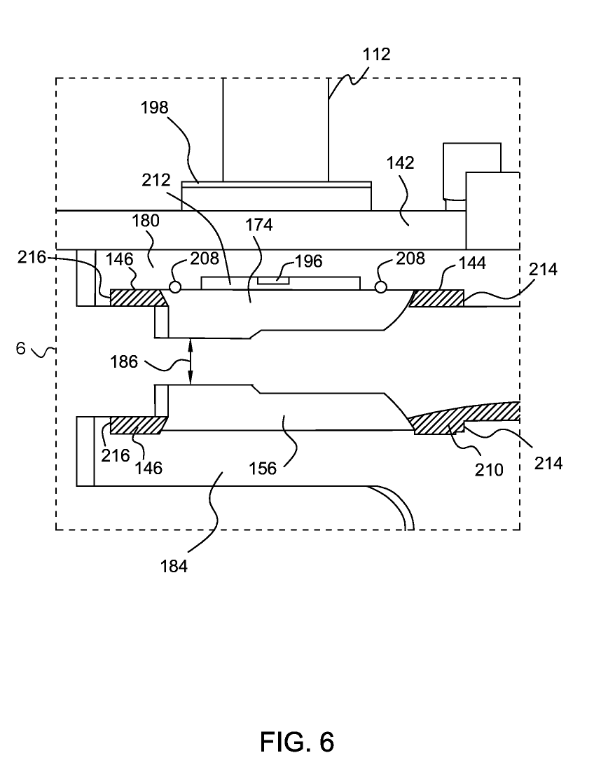

FIGS. 5 and 6 show disc mill 114 from the example embodiment from FIG. 1 with a cut away view along the line A-A from FIG. 1. FIG. 6 shows the area 6 from FIG. 5. The disc mill in some embodiments may include a stationary disc blade 174 that is held against a water jacket support 180 with multiple outer clamp segments 146, and with multiple inner clamp segments 144. The clamp segments 144, 146 may be held against the water jacket support with fasteners, and may have a portion that contacts the stationary disc blade 174 to hold the stationary disc blade 174 in place. The clamp segments 144, 146 may contact substantially all of the inner and outer circumference of the stationary disc blade 174.

A water cooling channel 212 maybe formed between the stationary disc blade 174 and the water jacket support 180. O-rings 208 may be placed between the water jacket support 180 and the stationary disc blade 174 to create a water-tight seal. Water or other fluid may be forced through the water cooling channel 212 to transfer heat from the inside of the mill housing 116 through the stationary disc blade 174 and then through the water or other fluid out of the mill housing 116 to cool the mill housing 116.

In some embodiments the disc mill 114 may include a rotating disc blade 156 that is held against a flywheel 184 with multiple outer clamp segments 146 and with an inner clamp hub. The multiple outer clamp segments 146 and the inner clamp hub 210 may be connected to the flywheel 184 with fasteners, and may contact substantially all of the inner circumference and the outer circumference of the rotating disc blade 156, to hold the rotating disc blade against the flywheel 184.

The flywheel 184 may have a pocket with a recessed area for the multiple outer clamp segments 146. The pocket may have an outer pocket edge 216. The flywheel 184 may be connected to a bushing 220 and a motor 218 through a shaft. The motor 218 may rotate the flywheel 184 with the rotating disc blade 156, creating a centrifugal force acting on the multiple outer clamp segments 146. The outer pocket edge 216 may support the multiple outer clamp segments 146 against the centrifugal force. If the outer pocket edge 216 were not supporting the multiple outer clamp segments 146 against the centrifugal force, then fasteners that hold the multiple clamp segments 146 against the flywheel 184 would support the position and act against the centrifugal force to keep the multiple outer clamp segments 146 in place. Fasteners may become fatigued and break, as fasteners are not usually designed to withstand a high sheering force. If the fastens break, then one of the multiple outer clamp segments 146 may be thrown away from the flywheel 184 by the centrifugal force. This may create a dangerous condition or may damage the mill housing 116 or other parts of the mill system 100.

The pocket may have an inner pocket edge 214. The water jacket support 180 may have an inner pocket edge 214 and an outer pocket edge 216. In some embodiments the stationary disc blade 174 and the rotating disc blade 156 may be interchangeable, and may be produced as the same part.

The use of multiple outer clamp segments 146 instead of a continuous ring may provide the advantage of preventing buckling of the clamp when fasteners are not tightened the same. The inner circumference of the stationary disc blade 174 may be held on with multiple inner clamp segments 144.

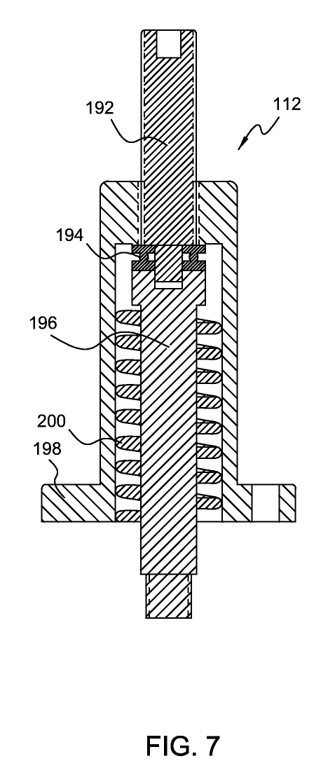

In some embodiments a blade adjuster 112 may be assembled and used as shown in FIGS. 5, 6 and 7. The blade adjuster 112 may have an adjuster set screw 192 that is threaded and is held by threads in an adjuster body 198. When the adjuster set screw 192 is turned, it may push down on an adjuster shoulder screw 196. An adjuster bearing 194 may be placed between the adjuster set screw 192 and the adjuster shoulder screw 196. The adjuster shoulder screw 196 may be inside the adjuster body 198 and may be able to move relative to the adjuster body 198. An adjuster spring 200 may force the adjuster should screw 196 against the adjuster bearing 194 to maintain a stable position of the adjuster shoulder screw 196. The adjuster shoulder screw 196 may pass through the mill door 142 and may be fastened to the water jacket support 180. In some embodiments the water jacket support is threaded and receives threads on the adjuster shoulder screw 196. The water jacket support 180 may be supported by multiple blade adjusters 112 so that the height of the water jacket support, and therefore the stationary disc blade, are changed when the adjuster set screw 192 is rotated.

The embodiments shown in the drawings are for illustration only and are not limiting. For example, the air inlets 118, 158 and the material outlets 124, 164 are shown as having round cross sections in the example embodiments, but in other embodiments the air inlets 118, 158 and the material outlets 124, 164 may have a square cross section shape or other shapes.

While the principles of the invention have been made clear in illustrative embodiments, there will be immediately obvious to those skilled in the art many modifications of structure, arrangement, proportions, and methods, the elements, materials, and components used in the practice of the invention, and otherwise, which are particularly adapted to specific environments and operative requirements without departing from those principles. The appended claims are intended to cover and embrace any and all such modifications, within the limits only of the true spirit and scope of the invention.

What is claimed is:

1. A method of cooling a disc mill having a rotating disc blade, the method comprising:
Drawing air through a first material outlet, wherein the first material outlet is positioned generally along a first line forming a first tangent to an outer circumference of the rotating disc blade,
Drawing air through a second material outlet, wherein the second material outlet is positioned generally along a second line forming a second tangent to the outer circumference of the rotating disc blade;
Directing a first air stream from a first air inlet along a first portion of the rotating disc blade to cool the rotating disc blade and pulverized material; and
Directing a second air stream from a second air inlet across a second portion of the rotating disc blade to cool the rotating disc blade and pulverized material.

2. The method of claim 1, wherein the step of directing the first air stream includes directing the first air stream generally along a third line that forms a third tangent to the outer circumference of the rotating disc blade.

3. The method of claim 2 wherein the step of directing the first air stream includes directing the first air stream generally along the third line at an angle relative to the first line between zero degrees and seventy degrees.

4. The method of claim 2 wherein the step of directing the first air stream includes directing the first air stream generally along the third line at an angle relative to the first line between five degrees and thirty-five degrees.

5. The method of claim 2 wherein the step of directing the first air stream includes directing the first air stream generally along the third line at an angle of approximately ten degrees relative to the first line.

6. The method of claim 2, wherein the step of directing the second air stream includes directing the second air stream generally along a fourth line that forms a fourth tangent to the outer circumference of the rotating disc blade.

7. The method of claim 6, wherein the step of directing the second air stream includes directing the second air stream generally along the fourth line at an angle relative to the first line between zero degrees and Seventy degrees.

8. The method of claim 2, wherein the step of directing the second air stream includes directing the second air stream generally along a fourth line that forms a fourth tangent to the outer circumference of the rotating disc blade, wherein the fourth line and the third line are generally along opposite tangents to the rotating disc blade.

9. The method of claim 1 wherein the step of drawing air through the second material outlet includes drawing air along the second line, wherein the first line and the second line are generally along opposite tangents to the rotating disc blade.

10. The method of claim 1 further comprising:
Measuring a first temperature inside the disc mill at the first material outlet with a first thermocouple;
Measuring a second temperature inside the disc mill at the second material outlet with a second thermocouple;
Measuring power to a motor that rotates the rotating disc blade; and
Regulating a volume of material introduced into the disc mill based on the power to the motor, the first temperature and the second temperature.

11. A disc mill housing for a rotating disc blade comprising:
Multiple material outlets in the disc mill housing including
a first material outlet wherein the first material outlet is positioned generally along a first line forming a first tangent to an outer circumference of the rotating disc blade, and
a second material outlet wherein the second material outlet is positioned generally along a second line forming a second tangent to the outer circumference of the rotating disc blade; and
Multiple air inlets in the disc mill housing including
a first air inlet generally along a third line that forms a third tangent to the outer circumference of the rotating disc blade, and
a second air inlet generally along a fourth line that forms a fourth tangent to the outer circumference of the rotating disc blade.

12. The disc mill housing according to claim 11 wherein the multiple material outlets are generally spaced evenly around the rotating disc blade.

13. The disc mill housing according to claim 11 wherein the multiple air inlets are generally spaced evenly around the rotating disc blade.

14. The disc mill housing according to claim 11 wherein the first line and the second line are generally along opposite tangents to the rotating disc blade.

15. The disc mill housing according to claim 12 wherein the third line and the fourth line are generally along opposite tangents to the rotating disc blade.

16. The disc mill housing according to claim 15 wherein the third line is at an angle relative to the first line of between zero degrees and seventy degrees.

17. The disc mill housing according to claim 11
wherein the multiple material outlets each have an outlet cross section with an outlet area,
wherein the outlet area is substantially equal for each of the multiple material outlets,
wherein the multiple air inlets each have an inlet cross section with an inlet area,
wherein the inlet area is substantially equal for each of the multiple air inlets, 1 0 wherein the inlet area is smaller than the outlet area.

18. A mill assembly comprising:
A disc mill housing including:
a first material outlet,
a second material outlet located about one-hundred-eighty degrees from the first material outlet,
a first air inlet, and
a second air inlet located about one-hundred-eighty degrees from the first air inlet;
A mill door including a hinge connected to the disc mill housing and fasteners to securely position the mill door relative to the disc mill housing;
A stationary blade assembly including:
A water jacket support connected to the mill door,
A stationary disc blade attached to the water jacket support, wherein the stationary disc blade is attached to the water jacket support with multiple inner clamp segments and multiple outer clamp segments;
A rotating blade assembly including:
A flywheel,
A rotating disc blade attached to the flywheel, wherein the rotating disc blade is attached to the flywheel with multiple outer clamp segments, wherein the rotating disc blade is positioned facing the stationary disc blade, with a gap between the rotating disc blade and the stationary disc blade;
A motor mechanically linked to the flywheel and configured to rotate the flywheel with the rotating disc blade relative to the stationary disc blade; and
A blade adjuster to change the gap between the rotating disc blade and the stationary disc blade.

19. The mill assembly of claim 18 wherein the first material outlet is positioned generally along a first line forming a first tangent to an outer circumference of the rotating disc blade, and wherein the second material outlet is positioned generally along a second line forming a second tangent to the outer circumference of the rotating disc blade, and wherein the first air inlet is positioned to direct a first air stream generally along a third line that forms a third tangent to the outer circumference of the rotating disc blade, and wherein the second air inlet is positioned to direct a second air stream generally along a fourth line that forms a fourth tangent to the outer circumference of the rotating disc blade.

20. The mill assembly of claim 19 wherein the third line is at an angle relative to the first line between zero degrees and seventy degrees.
